(19) United States
(12) Patent Application Publication
(10) Pub. No.: US 2009/0229639 A1
(43) Pub. Date: Sep. 17, 2009

(54) Particle Purge System

(75) Inventors: Tommy Joe Metzner, Longmont, CO (US); Nathaniel Patrick Sheppleman, Longmont, CO (US); Dennis Quinto Cruz, Longmont, CO (US); Sumit Chandra, Longmont, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/048,931

(22) Filed: Mar. 14, 2008

(51) Int. Cl. B08B 3/10

(52) U.S. Cl. 134/32; 134/147

(57) ABSTRACT

A particle purge system purges particles from an electronic device. The electronic device is inverted and secured to an interface plate included with the system. A clean purge fluid is injected into an inlet of the interface plate to release and remove particles in the electronic device. The particle purge system agitates the electronic device to enhance the release of particles from components in the electronic device into the purge fluid. At least a portion of the purge fluid that contains the released particles is exhausted through an outlet in the interface plate.

### BACKGROUND

A typical data storage system or disc drive includes a rigid housing that encloses a variety of components. The components can include a storage medium, usually in the form of one or more discs, having data surfaces for storage of digital information. The discs are mounted on a spindle motor that causes the discs to spin and the data surfaces of the discs to pass under aerodynamic bearing disc head sliders. The sliders carry transducers, which write information to and read information from the data surfaces of the discs.

One of the more prevalent reliability issues in disc drives are media failures caused by particles that contaminate the airflow in the housing of the disc drive. To increase recording area density, fly height is lowered and the disc is manufactured as smooth as possible. During disc drive operation, serious damage to the data surface of the disc and the sliders can result during lowered fly height if a particle were to become present between the disc and the slider.

Small and large particles released from drive components into the disc drive environment are unavoidable. Although disc drives employ recirculation filters to protect the disc from these particles, it is desirable to remove and quantify particles from the disc drive before the product is shipped to improve product quality and reliability.

### SUMMARY

A particle purge system purges particles from an electronic device. The particle purge system includes an interface plate having a top surface and a bottom surface. The interface plate includes a continuous wall that protrudes from the top surface of the interface plate and has a perimeter that follows an opening in the electronic device. The continuous wall includes an inner facing surface and an outer facing surface. The interface plate also includes an inlet and an outlet. The inlet extends between the top and bottom surfaces of the interface plate and is located inside the perimeter defined by the continuous wall. The outlet extends between the top and bottom surfaces of the interface plate and is located inside the perimeter defined by the continuous wall.

The electronic device is inverted and secured to the interface plate. A clean purge fluid is injected into the inlet of the interface plate to release and remove particles. The particle purge system also includes an agitator for agitating the electronic device to enhance the release of particles into the purge fluid. The purge fluid that contains the released particles is exhausted through the outlet in the interface plate.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a particle purge system in accordance with one embodiment.

FIG. 2 is a partial perspective view of the upper chamber of FIG. 1.

FIG. 3 is a bottom perspective view of the upper chamber illustrated in FIG. 1 and illustrated partially in FIG. 2.

FIG. 4 is a top perspective view of the lower chamber of FIG. 1.

FIG. 5 is an exploded perspective view of the lower chamber illustrated in FIGS. 1 and 4.

FIG. 6 is an enlarged partial side view of the lower chamber illustrated in FIGS. 1, 4 and 5.

FIG. 7 is a top perspective view of a lower chamber of a purge system in accordance with another embodiment.

FIG. 8 illustrates an exploded perspective view of the lower chamber illustrated in FIG. 7.

FIG. 9 is a top perspective view of a lower chamber of a purge system in accordance with yet another embodiment.

FIG. 10 illustrates an exploded perspective view of the lower chamber illustrated in FIG. 9.

FIG. 11 is a top perspective view of a lower chamber of a purge system in accordance with yet another embodiment.

FIG. 12 illustrates an exploded perspective view of the lower chamber illustrated in FIG. 11.

FIG. 13 is a perspective view of a particle purge system in accordance with another embodiment.

FIG. 14 is a perspective view of the particle purge system of FIG. 13 including an inverted base of a disc drive to be purged.

FIG. 15 is a process flow diagram illustrating a method of purging particles from an electronic device.

### DETAILED DESCRIPTION

In accordance with embodiments discussed in detail below, a base of a data storage system or disc drive is assembled with drive components and then subjected to a particle purge using a particle purge system. The particle purge system exposes the assembled base to a specific orientation, a shock input, controlled air flow and controlled evacuation to remove particulates. Besides removing particle contamination to ensure product quality, the particle purge system can also provide for the quantification and qualification of particles removed. Such a metrology feature adds additional benefits for process manufacturing improvement.

Although embodiments of the particle purge system are discussed in terms of use for a base of a disc drive, it should be realized that the particle purge system can be used to remove particles and allow for the quantification and qualification of particles in other types of electronic devices. For example, particle purge system can be used in various computing devices such as mobile phones, music players, video players and personal digital assistants. The following description discusses example embodiments of a particle purge system.

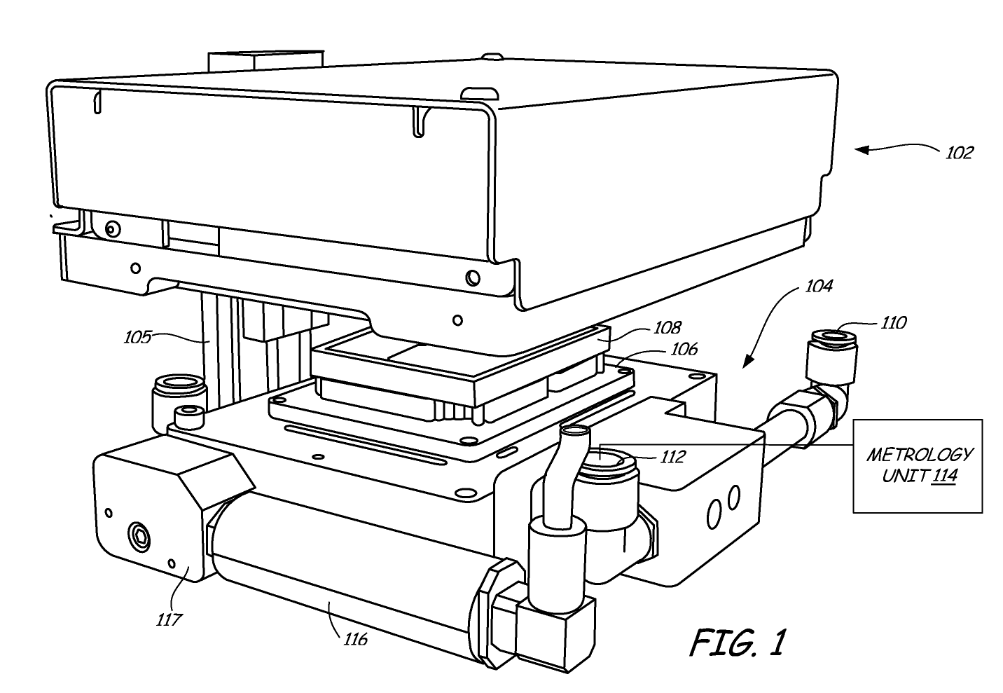

FIG. 1 is a perspective view of a particle purge system 100 in accordance with one embodiment. Particle purge system 100 includes an upper chamber 102 coupled to a lower chamber 104 by an arm 105. Lower chamber 104 is configured to support an inverted base 108 of a disc drive and deliver purge fluid to the base. Upper chamber 102 is configured to align and hold base 108 on lower chamber 104 as well as provide power to spin the disc(s) within the base and agitate the base to help loosen particles for removal. Upper chamber 102 moves along arm 105 between an active purge position and an inactive position. As illustrated in FIG. 1, upper chamber 102 is an inactive position. In an active position, an air cylinder attached to arm 105 lowers upper chamber 102 and forces the upper chamber to come into contact with base 108.

Lower chamber 104 includes an interface plate 106 for allowing a base 108 of a disc drive to interface with particle purge system 100. As previously discussed, although interface plate 106 is designed to interface with base 108, interface plate 106 can be configured to interface with any of various types of electronic devices. Coupled to lower chamber 104 are a purge fluid inlet port 110 and an exhaust outlet port 112. Inlet port 110 is configured to receive an injected fluid, such as clean dry air, to feed through lower chamber 104 and ultimately blow into base 108. Outlet port 112 is configured to exhaust the injected fluid that contains particles released from base 108 to a metrology unit 114. Metrology unit 114 is configured to qualify and quantify particles that are released and removed by the injected fluid from base 108. Also coupled to lower chamber 104 is a pressure transducer 116 and adapter block 117. Pressure transducer 116 provides information to a regulator for regulating the flow of purge fluid into inlet port 110. In one embodiment, flow should be regulated such that a positive pressure is maintained in lower chamber 104 and a pressure differential is limited to approximately 1 PSI.

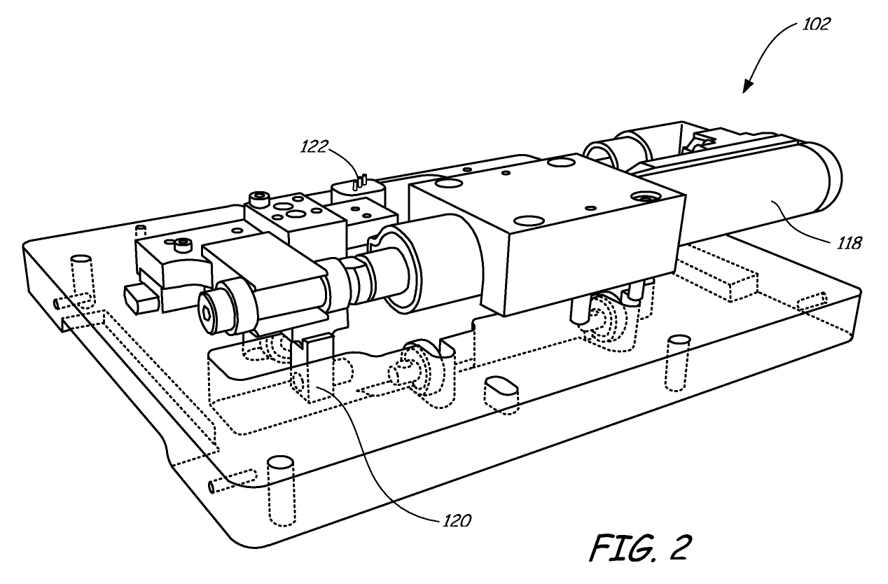

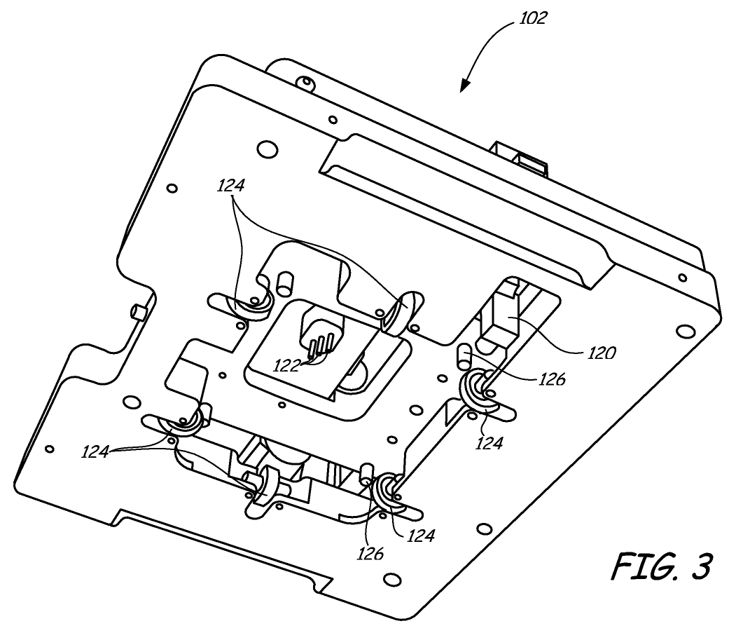

FIG. 2 illustrates a top perspective view of a portion of upper chamber 102 of the particle purge system 100 in FIG. 1. As illustrated in FIG. 2, some components of upper chamber 102 are located underneath the chamber and are illustratively shown in phantom lines. FIG. 3 illustrates a bottom perspective view of upper chamber 102.

Upper chamber 102 includes a motor 118 (FIG. 2). Motor 118 is configured to provide repeatable agitation to an agitator pin 120 (FIGS. 2 and 3). When upper chamber 102 is placed into an active position, agitator pin 120 comes into contact with base 108. By agitating base 108 during a purge, an enhanced release of particles will occur. Upper chamber 102 also includes pogo pins 122 (FIGS. 2 and 3) for connection to a spindle motor coupled to disc(s) assembled in base 108. Pogo pins 122 provide power to the spindle motor such that the disc(s) can be spun under control while particles are purged from base 108.

Upper chamber 102 also includes a plurality of datum rollers 124 and a plurality of hold down pins 126. As illustrated, upper chamber 102 includes six datum rollers 124 (FIGS. 2 and 3) and four hold pins 126 (FIG. 3). Datum rollers 124 align base 108 with interface plate 106 while hold pins 126 provide a non-metallic contact between base 108 and upper chamber 102. Example materials for hold pins 126 should exhibit properties that are well-suited for wear applications that otherwise would require a metal on metal contact. One example material is a polymer, such as Polyslick. However, other materials can be used.

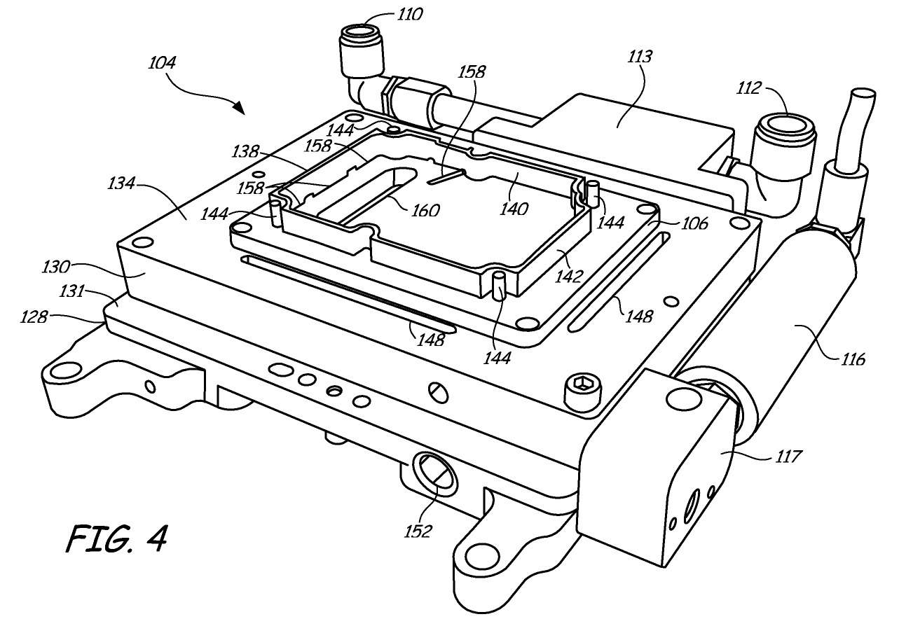

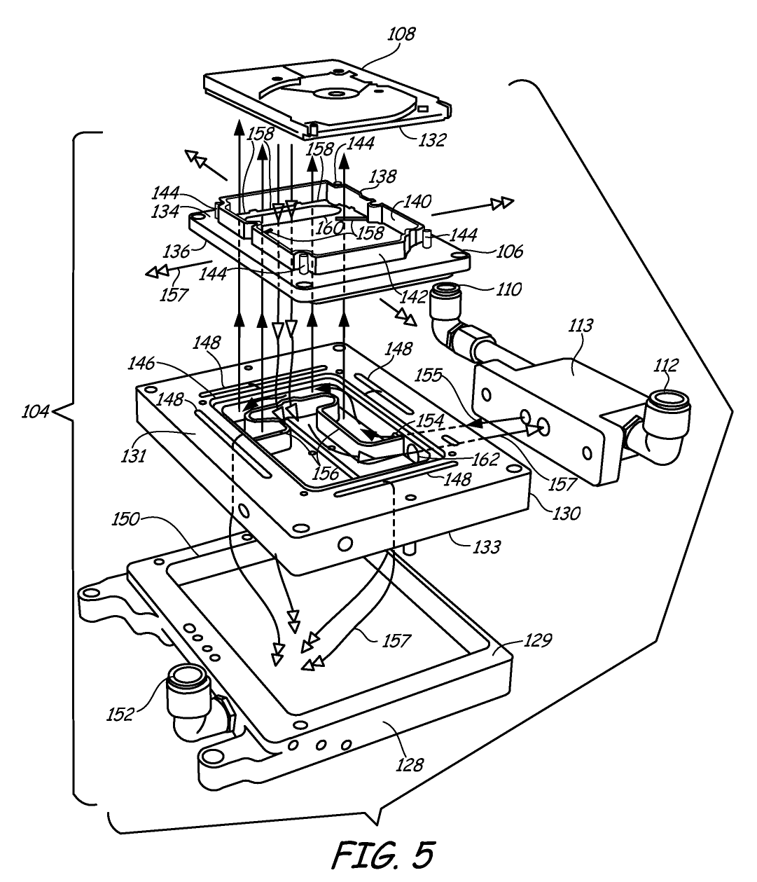

FIG. 4 illustrates a perspective view of lower chamber 104 of FIG. 1 while FIG. 5 illustrates an exploded perspective view of lower chamber 104. In FIG. 4, coupled to lower chamber 104 includes pressure transducer 116 and adapter block 117, while in FIG. 5 these components are removed. In both FIGS. 4 and 5, purge fluid inlet port 110 and exhaust outlet port 112 are illustrated with adapter block 113. Base 108 of a disc drive is illustrated in FIG. 5 exploded from interface plate 106. However, base 108 in FIG. 4 is removed to more clearly illustrate features of interface plate 106.

As illustrated in FIGS. 4 and 5, lower chamber 104 includes a bottom plate 128, a middle plate 130 and interface plate 106. As previously discussed, interface plate 106 is configured to interface with base 108 of a disc drive. Interface plate 106 is configured to interface or come into contact with at least a portion of an upper surface 132 of base 108. In other words, base 108 is inverted as illustrated in both FIGS. 1 and 5 to interface with interface plate 106.

With reference to FIGS. 4 and 5, interface plate 106 includes a top surface 134 and a bottom surface 136. A continuous wall 138 extends from top surface 134 of interface plate 106 and has a perimeter that closely follows a profile and path of a gasket located on upper surface 132 of base 108. A gasket generally surrounds an opening in upper surface 132 of base 108. It should be realized that there are numerous profiles of which continuous wall 138 could follow depending upon the design of the base of the disc drive. Continuous wall 138 is just one example.

Continuous wall 138 includes an inner facing surface 140 and an outer facing surface 142. Interface plate 106 also includes a plurality of supports 144. Supports 144 protrude and extend from top surface 134 of interface plate 106. Supports 144 are located outwardly from outer facing surface 142 of continuous wall 138 and are configured to support upper surface 132 of base 108. Like hold pins 126 located on upper chamber 102 illustrated in FIG. 3, supports 144 should also be made of a material that exhibits properties well-suited for wear applications that otherwise would require a metal on metal contact. For example, a polymer, such as Polyslick can be a suitable material. However, other materials can be used.

Middle plate 130 includes a top surface 131 and a bottom surface 133. Top surface 131 is coupleable to bottom surface 136 of interface plate 106. As illustrated in FIG. 5, middle plate 130 includes a recessed area 146 for directing clean purge fluid for delivery to interface plate 106 and purge fluid returning from the interface plate that contains particles. The purge fluid that contains particles is an exhaust fluid that is to be exhausted to a metrology unit, such as metrology unit 114 (FIG. 1), for particle quantification and qualification. Middle plate 130 also includes a plurality of slots 148 for use in exhausting purge fluid. As illustrated in FIGS. 4 and 5, middle plate 130 includes four slots 148. Each slot is spaced apart and located outwardly from recessed area 146. Each slot is also spaced apart and located outwardly from each side edge of interface plate 106 after the interface plate is attached to middle plate 130 as illustrated in FIG. 4. Slots 148 will be described in detail below in regards to the flow of fluid in particle purge system 100.

Bottom plate 128 includes a top surface 129 that is coupleable to bottom surface 133 of middle plate 130. As illustrated in FIG. 5, bottom plate 128 includes a recessed area 150 for receiving exhaust fluid to be exhausted through slots 148 in middle plate 130. Fluid exhausted through slots 148 is directed outside of lower chamber 104 to the environment through a port 152.

FIG. 5 illustrates the movement of fluid in lower chamber 104. The filled arrows represent a clean purge fluid 155 and the open arrows represent an exhaust fluid 157. In the embodiments illustrated, a clean purge fluid 155 is clean dry air. However, it should be realized that the fluid can be a variety of different types of gases or even liquids. To begin with, clean purge fluid 155 is injected into particle purge system 100 through inlet port 110. The clean purge fluid 155 travels through adapter block 113 and into a middle plate inlet port 154. The clean purge fluid 155 is directed within a channel 156, which occupies a portion of recessed area 146 in middle plate 130, and ultimately through an inlet in the form of inlet segments 158 in interface plate 106. Channel 156 is shaped to follow or match a shape and location of inlet segments 158 and an outlet in the form of an outlet segment 160 in interface plate 106. Clean purge fluid 155 is blown through inlet segments 158 into base 108 to release and remove particulates. Exhaust fluid 157 is evacuated through outlet segment 160 in interface plate 106 back towards middle plate 130.

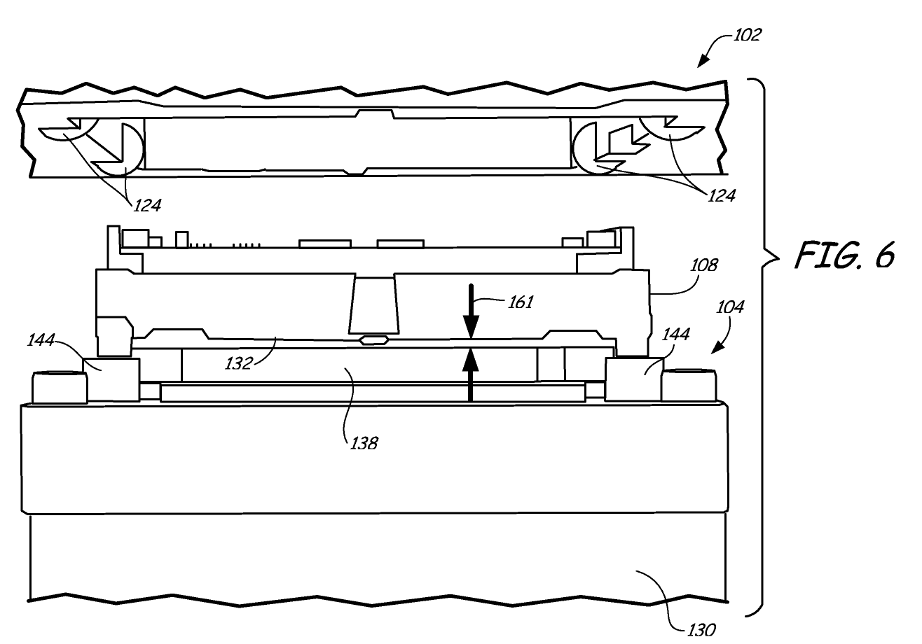

FIG. 6 illustrates an enlarged partial side view of lower chamber 104, upper chamber 102 and base 108. In FIG. 6, interface plate 106 and middle plate 130 of lower chamber 104 are partially illustrated, while datum rollers 124 are illustrated in the partial view of upper chamber 102. In the example embodiment illustrated in FIGS. 1-6, base 108 is resting on supports 144 and not in contact with continuous wall 138. Therefore, a portion of exhaust fluid 157 (FIG. 5) can be lost to the environment through a gap 161 (FIG. 6) between upper surface 132 of base 108 and continuous wall 138. A remaining portion of exhaust fluid will be directed into recessed area 146 (outside of channel 156), through an outlet port 162 (FIG. 5) into adapter block 113 (FIG. 5) and ultimately through exhaust outlet port 112 (FIGS. 1 and 5) to a metrology unit, such as metrology unit 114 (FIG. 1).

The loss of exhaust fluid 157 through gap 161 (FIG. 6) between continuous wall 138 and upper surface 132 of base 108 to the environment can occur in two forms. As indicated by the double open arrows illustrated adjacent the edges of interface plate 106 in FIG. 5, exhaust fluid 157 can exit directly to the environment. Exhaust fluid 157 can also be lost to the environment through slots 148 as indicated by the double open arrows that flow from middle plate 130 into bottom plate 128. As previously discussed, fluid exhausted through slots 148 is directed into bottom plate 128 and outside of lower chamber 104 to the environment through port 152. In one embodiment, port 152 can be connected to a vacuum such that the exhaust is forced outside of lower chamber 104.

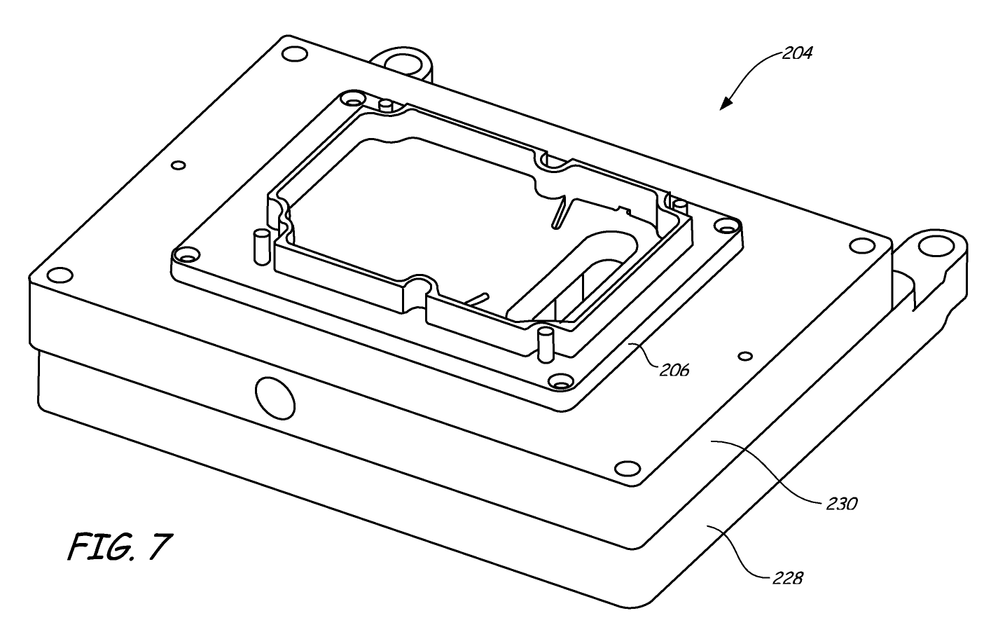

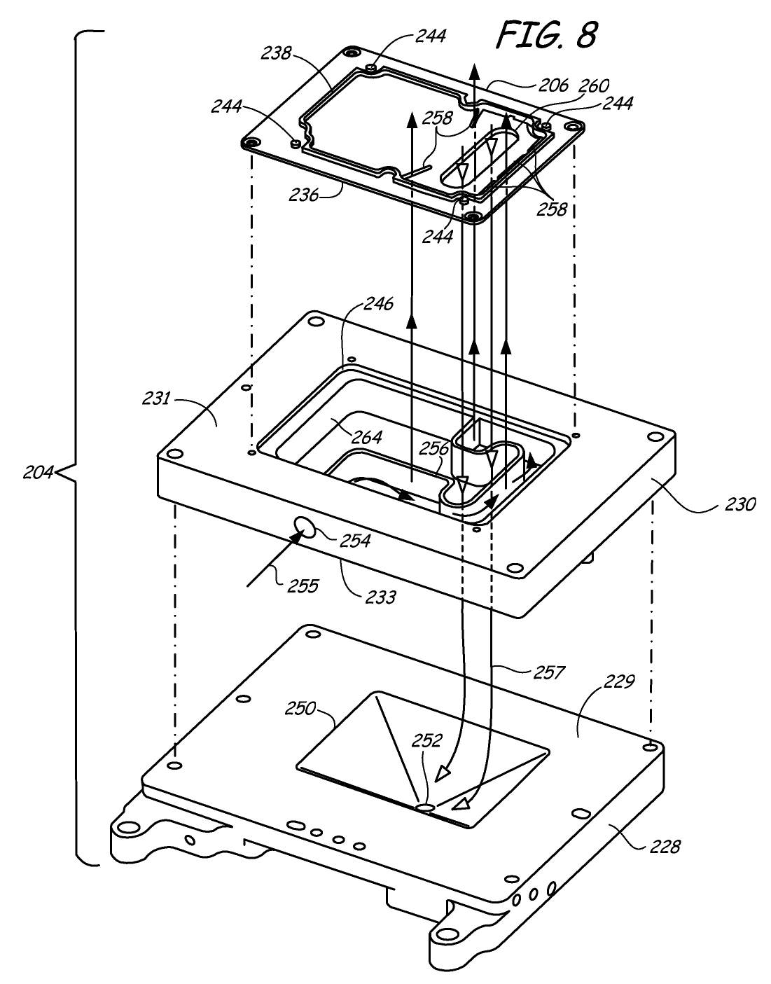

FIG. 7 is a top perspective view of a lower chamber 204 of a particle purge system in accordance with another embodiment. For example, lower chamber 204 can be used with particle purge system 100. Like lower chamber 104 illustrated in FIGS. 1 and 4-6, lower chamber 204 includes an interface plate 206, a middle plate 230 and a bottom plate 228. Interface plate 206, middle plate 230 and bottom plate 228 are similar to interface plate 106, middle plate 130 and bottom plate 128. However, middle plate 230 and bottom plate 228 include features that are different from those features of middle plate 130 and bottom plate 128 as will be explained in detail in FIG. 8.

FIG. 8 illustrates an exploded perspective view of lower chamber 204 including interface plate 206, middle plate 230 and bottom plate 228. Interface plate 206 includes all of the same features as interface plate 206 including supports 244 for receiving an upper surface of a base of a disc drive. With supports 244, a base of a disc drive will not contact continuous wall 238 and will be separated by a gap. As discussed in regards to interface plate 106, continuous wall 238 of interface plate 206 matches a profile and path of a gasket on the upper surface of the base. The gasket generally surrounds an opening in the upper surface of the base.

Middle plate 230 includes a top surface 231 and a bottom surface 233. Top surface 231 is coupleable to bottom surface 236 of interface plate 206. As illustrated in FIG. 8, middle plate 230 includes a recessed area 246 for directing clean purge fluid for delivery to interface plate 206 and purge fluid returning from the interface plate that contains particles to be exhausted to a metrology unit, such as metrology unit 114 (FIG. 1), for particle quantification and qualification. Recessed area 246 includes a channel 256 for delivering clean purge fluid to a base supported by supports 244 of interface plate 206. Channel 256 occupies a portion of recessed area 246 and is shaped to follow or match a shape and location of an inlet in the form of inlet segments 258 and an outlet in the form of an outlet segment 260 in interface plate 206. A remaining portion of recessed area 246 includes an aperture 264 extending between top surface 231 and bottom surface 233 of middle plate 230. Aperture 264 exhausts fluid to a metrology unit.

Bottom plate 228 includes a top surface 229 that is coupleable to bottom surface 133 of middle plate 230. As illustrated in FIG. 8, bottom plate 228 includes a recessed area 250 for receiving exhaust fluid to be exhausted through aperture 264 in middle plate 230. Recessed area 250 is a tapered recess that funnels to a port 252 at a bottom end of bottom plate 228. Fluid exhausted through aperture 264 is directed outside of lower chamber 204 to a metrology unit, such as unit 114 illustrated in FIG. 1, through port 252. Middle plate 230 includes aperture 264 in recessed area 246 that directs exhaust fluid downwards instead of through a side outlet, like outlet port 162 of middle plate 130. Bottom plate 228 includes port 252 that also directs exhaust fluid downwards. These configurations are much better at exhausting particles from lower chamber 204 than exhausting particles from lower chamber 104. Particles, especially larger sized particles, have difficulty following the bending pathways that are included in the embodiment illustrate in FIGS. 4-5. In addition, middle plate 230 does not need slots for directing exhaust fluid lost to the environment through a gap between the base and continuous wall 238. Little exhaust fluid will escape through the gap between the base and continuous wall 238 because of the downward evacuation of exhaust fluid.

FIG. 8 also illustrates the movement of fluid in lower chamber 204. The filled arrows represent a clean purge fluid 255 and the open arrows represent an exhaust fluid 257. In the embodiments illustrated, clean purge fluid 255 is clean dry air. However, it should be realized that the fluid can be a variety of different types of gases or liquids. To begin with, clean purge fluid 255 is injected into lower chamber 204 through middle plate inlet port 254. The clean purge fluid 255 is directed within channel 256, which occupies a portion of recessed area 246 in middle plate 230, and ultimately through inlet segments 258 in interface plate 206. Through inlet segments 258, clean purge fluid 255 is blown into a base that is resting on supports 244 to release and remove particulates. Exhaust fluid 257 is evacuated through outlet segment 260 in interface plate 206, through aperture 264 of middle plate 230 to a metrology unit through port 252.

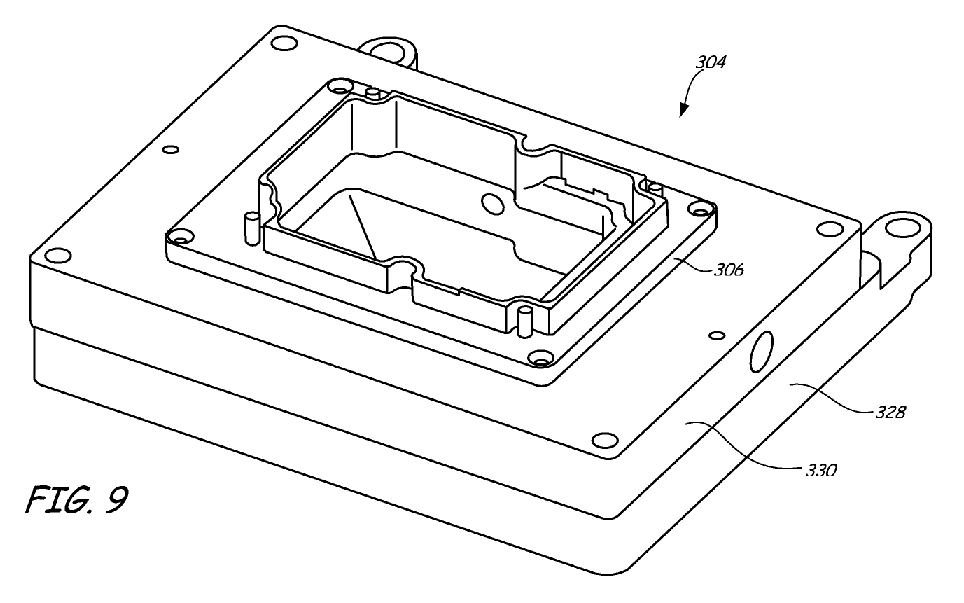

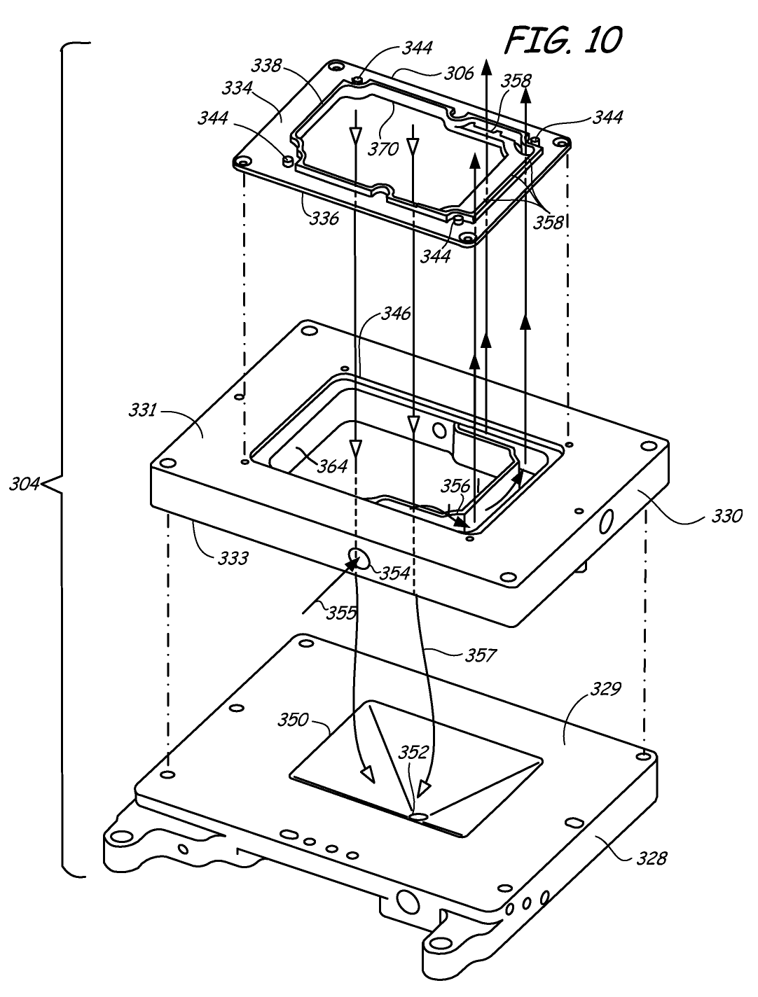

FIG. 9 is a top perspective view of a lower chamber 304 of a particle purge system in accordance with yet another embodiment. For example, lower chamber 304 can be used with particle purge system 100. Like lower chambers 104 (FIGS. 1 and 4-6) and 204 (FIGS. 7-8), lower chamber 304 includes an interface plate 306, a middle plate 330 and a bottom plate 328. Interface plate 306, middle plate 330 and bottom plate 328 are similar to interface plates 106 and 206, middle plates 130 and 230 and bottom plates 128 and 228. However, interface plate 206 and middle plate 330 include features that are different from those features of interface plate 206 and middle plate 230 as ill be explained in detail in FIG. 10.

FIG. 10 illustrates an exploded perspective view of lower chamber 304 including interface plate 306, middle plate 330 and bottom plate 328. Interface plate 306 includes similar features as interface plates 106 and 206 including supports 344 for receiving an upper surface of a base of a disc drive such that the base is not in contact with continuous wall 338 and is separated by a gap. However, interface plate 306 also includes an outlet aperture 370 extending between a top surface 334 and a bottom surface 336 of interface plate 306 instead of an outlet segment, such as outlet segments 160 and 260 of interface plates 106 and 206. As discussed in regards to interface plate 106, continuous wall 338 of interface plate 306 matches a profile of a gasket on the upper surface of the base. The gasket generally surrounds an opening in the upper surface of the base.

Middle plate 330 includes a top surface 331 and a bottom surface 333. Top surface 331 is coupleable to bottom surface 336 of interface plate 306. As illustrated in FIG. 10, middle plate 330 includes a recessed area 346 for directing clean purge fluid for delivery to interface plate 306 and purge fluid returning from the interface plate that contains particles to be exhausted to a metrology unit, such as metrology unit 114 (FIG. 1), for particle quantification and qualification. Recessed area 346 includes a channel 356 for delivering clean purge fluid to a base supported by supports 344 of interface plate 306. Channel 356 occupies a portion of recessed area 346 and is shaped to follow or match a shape and location of an inlet in the form of inlet segments 358 and outlet aperture 370. Like middle plate 230, a remaining portion of recessed area 346 includes an aperture 364 extending between top surface 331 and bottom surface 333. Aperture 364 exhausts fluid to a metrology unit.

Bottom plate 328 includes a top surface 229 that is coupleable to bottom surface 333 of middle plate 330. As illustrated in FIG. 10, bottom plate 328 includes a recessed area 350 for receiving exhaust fluid to be exhausted through aperture 364 in middle plate 330. Recessed area 350 is a tapered recess that funnels to a port 352. Fluid exhausted through aperture 364 is directed outside of lower chamber 304 to a metrology unit, such as unit 114 illustrated in FIG. 1, through port 352 at a bottom end of bottom plate 328. Middle plate 330 includes aperture 364 in recessed area 346 that directs exhaust fluid downwards instead of through a side outlet, like outlet port 162 of middle plate 130. Bottom plate 328 includes port 352 that also directs exhaust fluid downwards. These configurations are much better at exhausting particles from lower chamber 204 than exhausting particles from lower chamber 104. Particles, especially larger sized particles have difficulty following the bending pathways that are included in the embodiment illustrate in FIGS. 4-5. In addition, middle plate 330 does not need slots for directing exhaust fluid lost to the environment through a gap between the base and continuous wall 338. Little exhaust fluid will escape through the gap between the base and continuous wall 338 because of the downward evacuation of exhaust fluid.

FIG. 10 also illustrates the movement of fluid in lower chamber 304. The filled arrows represent a clean purge fluid 355 and the open arrows represent an exhaust fluid 357. In the embodiments illustrated, clean purge fluid 355 is clean dry air. However, it should be realized that the fluid can be a variety of different types of gases or even liquids. To begin with, clean purge fluid 355 is injected into lower chamber 304 through middle plate inlet port 354. The clean purge fluid 355 is directed within channel 356, which occupies a portion of recessed area 346 in middle plate 330, and ultimately through inlet segments 358 in interface plate 206. Through inlet segments 358, clean purge fluid 355 is blown into a base that is resting on supports 344 to release and remove particulates. Exhaust fluid 357 is exhausted through outlet aperture 370 in interface plate 306, through aperture 364 of middle plate 330 to a metrology unit through port 352.

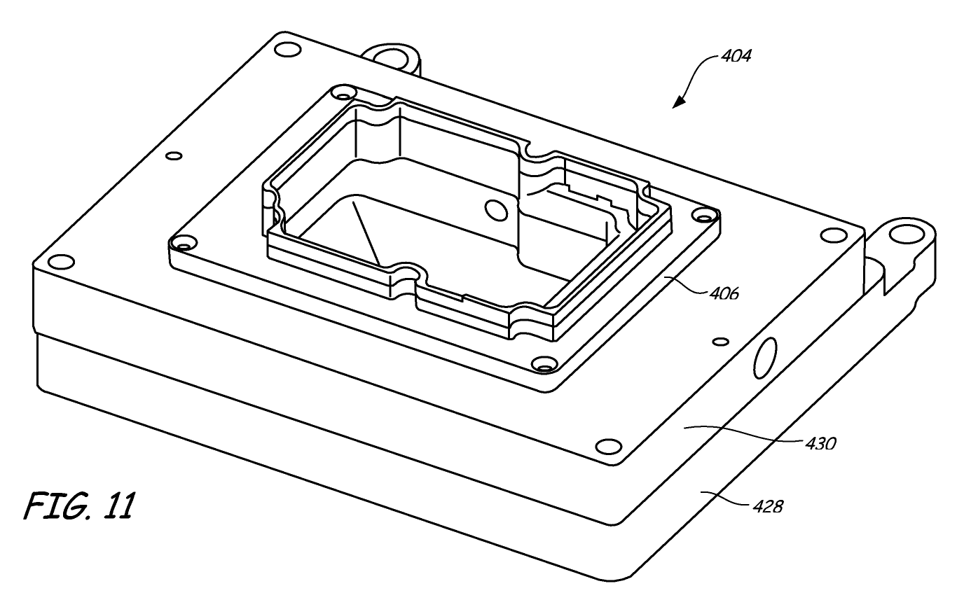

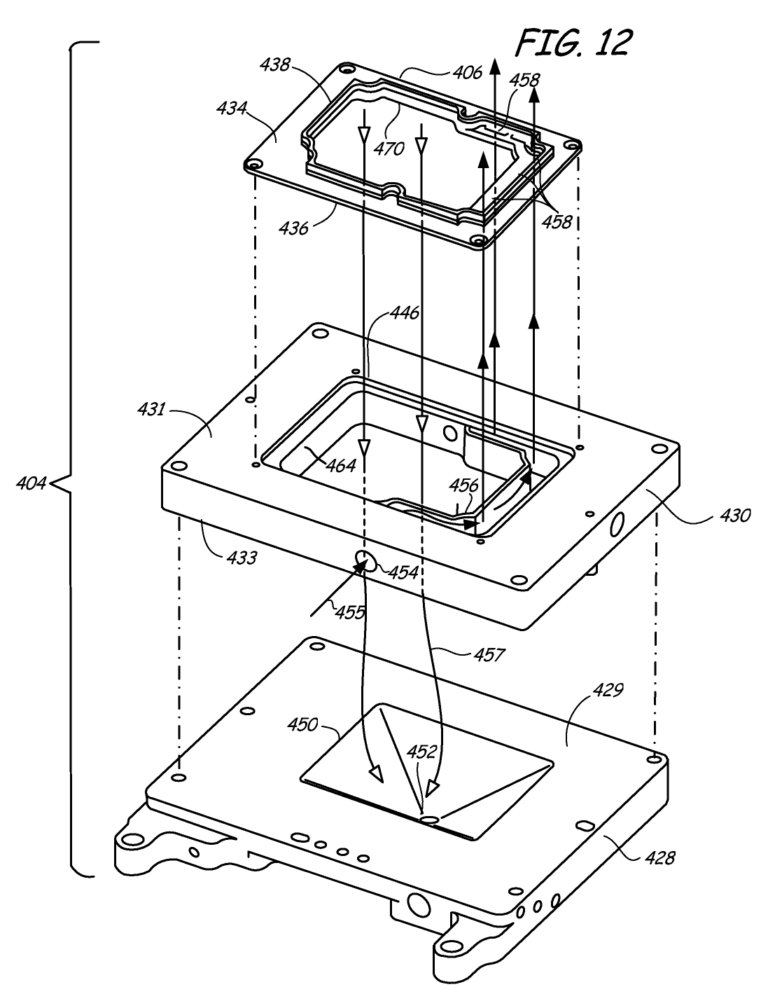

FIG. 11 is a top perspective view of a lower chamber 404 of a particle purge system in accordance with yet another embodiment. For example, lower chamber 404 can be used with particle purge system 100. Like lower chambers 104 (FIGS. 1 and 4-6), 204 (FIGS. 7-8) and 304 (FIGS. 9-10), lower chamber 404 includes an interface plate 406, a middle plate 430 and a bottom plate 428. Interface plate 406, middle plate 430 and bottom plate 428 are similar to interface plates 106, 206 and 306, middle plates 130, 230 and 330 and bottom plates 128, 228 and 328. However, interface plate 206 includes features that are different from those features of interface plate 306 as will be explained in detail in FIG. 12.

FIG. 12 illustrates an exploded perspective view of lower chamber 404 including interface plate 406, middle plate 430 and bottom plate 428. Interface plate 406 includes some similar features as interface plate 306 including an exhaust aperture 470. Unlike interface plates 106, 206 and 306, interface plate 406 does not include supports for receiving and supporting a base of disc drive. Instead, continuous wall 438 that protrudes from top surface 434 of interface plate 406 is configured to seal with a gasket on an upper surface of the base. The gasket generally surrounds an opening in the upper surface of the base.

Middle plate 430 includes a top surface 431 and a bottom surface 433. Top surface 331 is coupleable to bottom surface 336 of interface plate 406. As illustrated in FIG. 12, middle plate 430 includes a recessed area 446 for directing clean purge fluid for delivery to interface plate 306 and purge fluid returning from the interface plate contains particles to be exhausted to a metrology unit, such as metrology unit 114 (FIG. 1), for particle quantification and qualification. Recessed area 446 includes a channel 456 for delivering clean purge fluid to a base that is sealed to continuous wall 438 of interface plate 406. Channel 456 occupies a portion of recessed area 446 and is shaped to follow or match a shape and location of an inlet in the form of inlet segments 458 and an outlet in the form of outlet aperture 470 of interface plate 206. Like middle plates 230 and 330, a remaining portion of recessed area 446 includes an aperture 464 extending between top surface 431 and bottom surface 433 of middle plate 430. Aperture 464 exhausts fluid to a metrology unit.

Bottom plate 428 includes a top surface 329 that is coupleable to bottom surface 433 of middle plate 430. As illustrated in FIG. 12, bottom plate 428 includes a recessed area 450 for receiving exhaust fluid to be exhausted through aperture 464 in middle plate 430. Recessed area 450 is a tapered recess that funnels to a port 452 at a bottom end of bottom plate 328. Fluid exhausted through aperture 464 is directed outside of lower chamber 404 to a metrology unit, such as unit 114 illustrated in FIG. 1, through port 452. Interface plate 406 is sealed to an upper surface of a base, middle plate 430 includes aperture 464 in recessed area 446 that directs exhaust fluid downwards instead of through a side outlet, like outlet port 162 of middle plate 130. Bottom plate 428 includes port 452 that also direct exhaust fluid downwards. These configurations are much better at exhausting particles from lower chamber 404 than exhausting particles from lower chamber 104. Particles, especially larger sized particles, have difficulty following the bending pathways that are included in the embodiment illustrate in FIGS. 4-5. In addition, middle plate 430 does not need slots for directing exhaust fluid lost to the environment because of the downward evacuation of the exhaust fluid.

FIG. 12 also illustrates the movement of fluid in lower chamber 404. The filled arrows represent a clean purge fluid 455 and the open arrows represent an exhaust fluid 457. In the embodiments illustrated, clean purge fluid 455 is clean dry air. However, it should be realized that the fluid can be a variety of different types of gases or even liquids. To begin with, clean purge fluid 455 is injected into lower chamber 404 through middle plate inlet port 454. The clean purge fluid 455 is directed within channel 456, which occupies a portion of recessed area 446 in middle plate 430, and ultimately through inlet segments 458 in interface plate 406. Through inlet segments 458, clean purge fluid 455 is blown into a base that is sealed to continuous wall 438 to thereby release and remove particulates. Exhaust fluid is evacuated through outlet aperture 470 in interface plate 406, through aperture 464 of middle plate 430 to a metrology unit through port 452.

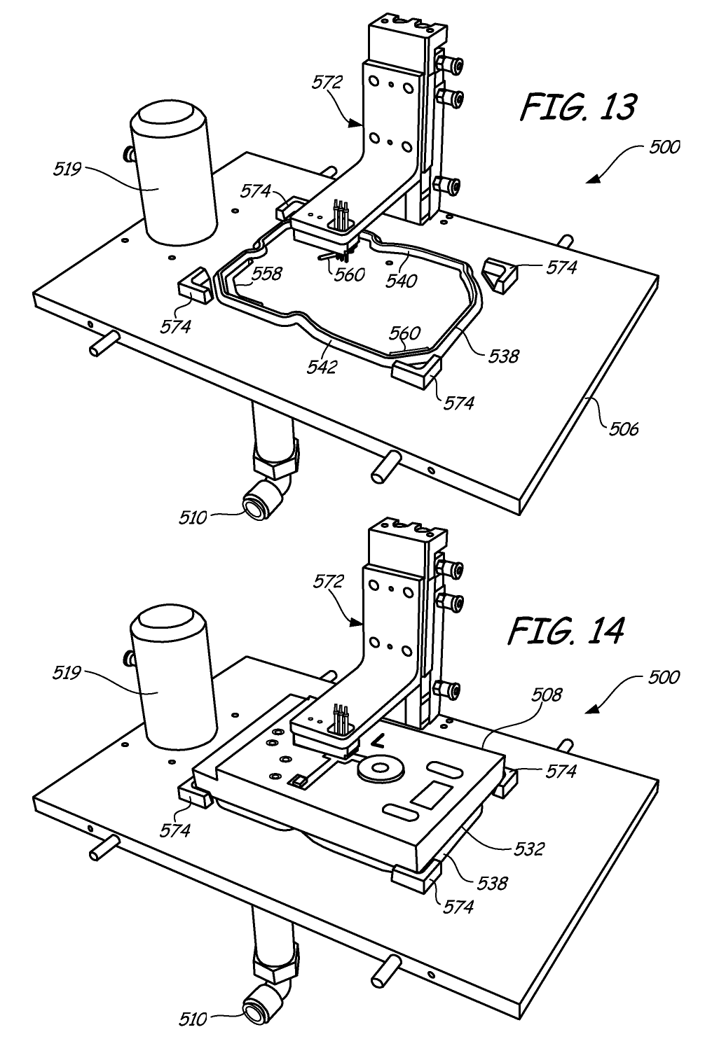

FIGS. 13 and 14 are top perspective views of a particle purge system 500 in accordance with another embodiment. FIG. 13 illustrates particle purge system 500 without a mounted base of a disc drive and FIG. 14 illustrates particle purge system 500 with a mounted base. Particle purge system 500 includes an interface plate 506 and an upper arm 572. Interface plate 506 is configured to support an inverted base 508 of a disc drive and deliver clean purge fluid to the base. Upper arm 572 is configured to hold base 508 in an active purge position on interface plate 506 as well as provide power to spin the media within the base.

Although interface plate 506 is designed to interface with base 508, interface plate 506 can be configured to interface with any of various types of electronic devices. Interface plate 506 includes guide blocks 574 and a continuous wall 538. Continuous wall 538 extends from top surface 534 of interface plate 506 and has a perimeter that closely follows a profile of a gasket located on upper surface 532 of base 508. The gasket generally surrounds an opening in upper surface 532 of the base. Continuous wall 538 includes an inner facing surface 540 and an outwardly facing surface 542. Interface plate 506 includes four guide blocks 574 located at each corner outwardly from outwardly facing surface 542 around continuous wall 538 to both support an upper surface 532 of base 508 as well as align the base with interface plate 506. Example materials for guide blocks 574 should exhibit properties that are well-suited for wear applications that otherwise would require a metal on metal contact. One example material is a polymer, such as Polyslick. However, other materials can be used. Interface plate 506 also includes an agitator 519 for agitating base 508 to help loosen particles for removal.

Under interface plate 506, a clean purge fluid, such as clean dry air, is injected into purge particle system 500 through an inlet port 510. However, it should be realized that the fluid can be a variety of different types of gases or even liquids. The clean purge fluid travels from inlet port 510 through an optional ionizer (hidden from view) and ultimately through an inlet in the form of an inlet segment 558 in interface plate 506. Through inlet segment 558, purge fluid is blown into base 508 to release and remove particulates.

Exhaust fluid that contains the released particles is then exhausted from base 508 by exiting base 508 through an outlet in the form of outlet segments 560 in interface plate 106 to an exhaust port (hidden from view) underneath interface plate 506. The exhaust port is configured to exhaust the fluid to a metrology unit, such as metrology unit 114 (FIG. 1). The metrology unit is configured to qualify and quantify particles that are being removed or purged from base 508. In the embodiment illustrated in FIGS. 13-14, base 508 is resting on guide block 574 and not in contact with continuous wall 538. Therefore, a portion of exhaust fluid can be lost to the environment through a gap between upper surface 532 of base 508 and continuous wall 538.

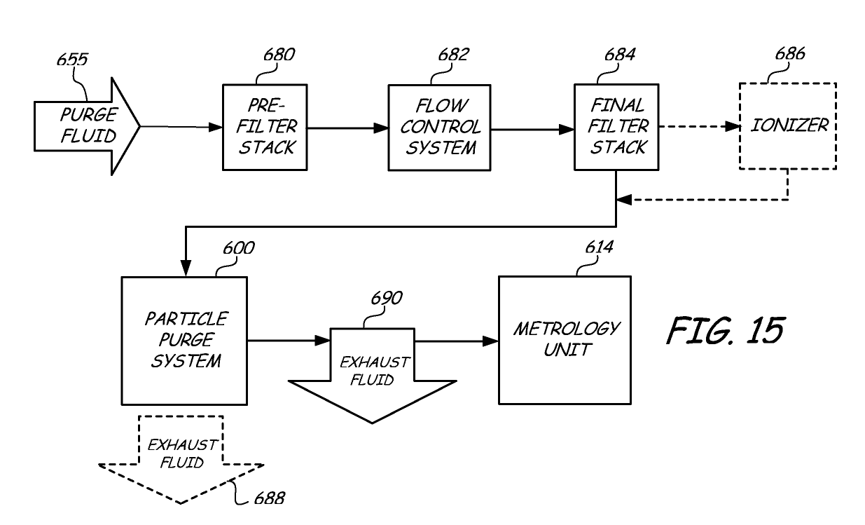

FIG. 15 illustrates a process flow diagram 675 illustrating the flow of fluid for a method of purging particles from an electronic device, such as a base of a disc drive. At block 680, a clean purge fluid 655 enters a pre-filter stack 682. As discussed above, purge fluid can be any type of gas or liquid for use in purging contaminates from an electronic device. For example, purge fluid 655 can be clean dry air. At pre-filter stack 682, any contaminates that have yet to be taken out of clean purge fluid 655 are filtered out.

Clean purge fluid 655 then enters a flow control system 682. At flow control system 682, clean purge fluid 655 is regulated to a particular flow rate with the use of a regulator. The flow rate is determined based on a pressure transducer included in the particle purge system 600. The flow rate is selectable based on maintaining a positive pressure in particle purge system 600. Clean purge fluid 655 then enters a final filter stack 684. Final filter stack 684 ensures that no new contaminates have been introduced since the regulation of flow.

Purge fluid 655 then optionally enters an ionizer 686. Ionizer 686 is an optional implementation to ensure that no static charges exists in the clean purge fluid. Finally, clean purge fluid 655 enters particle purge system 600 to release and remove particle contamination from an electronic device that is coupled to the particle purge system 600. To enhance particle removal, especially in a disc drive embodiment, particle purge system 600 operates and controls the spin of a spindle motor that rotates the media as well as agitates the base to help loosen particles without degrading the disc drive.

After purge fluid 655 has purged the electronic device, the purge fluid that contains particles is exhausted. In the embodiments illustrated in FIGS. 1-10 and 13-14, there are two forms of exhaust fluid since the base of the disc drive is not sealed to particle purge system or that the outlet port is not at bottom end of the purge system. The first form of exhaust fluid 688 is vented to the environment. The second form of exhaust fluid 690 is vented to a metrology unit 614 for particle quantification and qualification.

It is to be understood that even though numerous characteristics and advantages of various embodiments of the invention have been set forth in the foregoing description, together with details of the structure and function of various embodiments, this disclosure is illustrative only, and changes may be made in detail, especially in matters of structure and arrangement of parts within the principles of the disclosure to the full extent indicated by the broad general meaning of the terms in which the appended claims are expressed. For example, the particular elements may vary depending on the type of electronic device that is to be purged while maintaining substantially the same functionality without departing from the scope and spirit of the present invention. In addition, although the preferred embodiment described herein is directed to purging a base of a disc drive, it will be appreciated by those skilled in the art that the teachings of the present invention can be applied to other components of other types of electronic devices, without departing from the scope and spirit of the present invention.

What is claimed is:

1. A method of purging particles from an electronic device, the method comprising:
inverting the electronic device to secure at least a portion of an upper surface of the electronic device to an interface plate;
injecting a clean purge fluid into an inlet of the interface plate to release and remove particles from components in the electronic device into the purge fluid;
agitating the electronic device to enhance the release of particles from components in the electronic device into the purge fluid; and
exhausting the purge fluid that contains the released particles through an outlet in the interface plate.

2. The method of claim 1, wherein the electronic device comprises a base of a disc drive.

3. The method of claim 1, wherein exhausting the purge fluid that contains the released particles through an outlet in the interface plate comprises exhausting the purge fluid that contains the released particles to a metrology unit for particle analysis.

4. A particle purge system comprising:
an interface plate having a top surface and a bottom surface, the interface plate comprising:
a continuous wall protruding from the top surface of the interface plate and having a perimeter that closely follows an opening in an electronic device, the continuous wall including an inner facing surface and an outer facing surface;
an inlet extending between the top and bottom surfaces of the interface plate and located inside the perimeter defined by the continuous wall, the inlet configured to direct a clean purge fluid into the electronic device for releasing and removing particles;
an outlet extending between the top and bottom surfaces of the interface plate and located inside the perimeter defined by the continuous wall, the outlet configured to exhaust the purge fluid that contains the released particles out of the electronic device; and
an agitator for agitating the electronic device to enhance the release of particles into the purge fluid.

5. The particle purge system of claim 4, wherein the opening in the electronic device is surrounded by a gasket of which a profile and a perimeter of the continuous wall substantially matches.

6. The particle purge system of claim 5, wherein the continuous wall is configured to seal with the gasket of the electronic device when the electronic device is inverted for purging.

7. The particle purge system of claim 5, wherein the continuous wall of the interface plate is separated from the gasket of the electronic device by a gap when the electronic device is inverted for purging.

8. The particle purge system of claim 4, wherein the interface plate further comprises a plurality of supports coupled to and protruding from the top surface of the interface plate and located outwardly from the outwardly facing surface of the continuous wall, the plurality of supports configured to support the inverted electronic device.

9. The particle purge system of claim 4, wherein the interface plate further comprises a plurality of guide blocks coupled to the top surface of the interface plate and located outwardly from the outwardly facing surface of the continuous wall, the plurality of guide blocks configured to support and align the inverted electronic device with the continuous wall.

10. A particle purge system comprising:
a lower chamber comprising:
an interface plate configured to support an inverted electronic device and having a top surface and a bottom surface, the interface plate including:
an inlet extending between the top and bottom surfaces of the interface plate and configured to direct a clean purge fluid into the electronic device for releasing and removing particles;
an outlet extending between the top and bottom surfaces of the interface plate configured to exhaust the purge fluid that contains particles out of the electronic device;
a middle plate coupled to the bottom surface of the interface plate and including a recessed area, the recessed area configured to receive and direct the clean purge fluid towards the inlet of the interface plate, receive the purge fluid that contains particles from the outlet of the interface plate and direct the purge fluid that contains particles towards at least one exhaust port;
a bottom plate configured to exhaust the purge fluid that contains particles; and
an upper chamber configured to hold and align the electronic device to the interface plate, the upper chamber having an agitating component configured to contact and agitate the electronic device to enhance the release of particles into the purge fluid.

11. The particle purge system of claim 10, wherein the interface plate further comprises a continuous wall protruding from the top surface of the interface plate and having a perimeter that follows an opening in an upper surface of an electronic device, the continuous wall including an inwardly facing surface and an outwardly facing surface.

12. The particle purge system of claim 11, wherein the interface plate further comprises a plurality of supports coupled to and protruding from the top surface of the interface plate and located outwardly from the outwardly facing surface of the continuous wall, the plurality of supports configured to support the inverted electronic device.

13. The particle purge system of 12, wherein the upper chamber further comprises a plurality of pins and a plurality of datum rollers, the plurality of pins configured to contact a surface of the electronic device to hold the electronic device and the plurality of datum rollers configured to align the opening in the electronic device with the continuous wall on the interface plate.

14. The particle purge system of claim 11, wherein the interface plate further comprises a plurality of guide blocks coupled to the top surface of the interface plate and located outwardly from the outwardly facing surface of the continuous wall, the plurality of guide blocks configured to support and align the opening in the electronic device with the continuous wall.

15. The particle purge system of claim 10, wherein the recessed area of the middle plate further comprises a channel for directing the clean purge fluid towards the inlet of the interface plate, the channel having a shape that follows the shape of the inlet of the interface plate.

16. The particle purge system of claim 10, wherein the middle plate comprises the at least one exhaust port coupled to the recessed area to direct at least some of the purge fluid that contains particles to a metrology unit for quantification and qualification of the particles.

17. The particle purge system of claim 10, wherein the recessed area of the middle plate comprises an aperture extending from a top surface to a bottom surface, the aperture configured to direct the purge fluid that contains particles through the bottom plate and ultimately to a metrology unit for quantification and qualification of the particles.

18. The particle purge system of claim 17, wherein the bottom plate comprises an exhaust port located at a bottom end for exhausting the purge fluid containing particles to the metrology unit.

19. The particle purge system of claim 10, wherein the middle plate comprises a plurality of slots extending between a top surface a bottom surface, the slots located outwardly from the recessed area and configured to receive a portion of the purge fluid that contains particles that was exhausted through a gap between the electronic device and the interface plate.

20. The particle purge system of claim 19, wherein the bottom plate comprises an exhaust port configured to exhaust to a surrounding environment the portion of the purge fluid that contains particles received through the plurality of slots to an exhaust port coupled to the environment.
